(19) United States
(12) Patent Application Publication
(10) Pub. No.: US 2008/0239253 A1
(43) Pub. Date: Oct. 2, 2008

(54) OPTICAL ELEMENT AND PROJECTION SYSTEM USING THE SAME

(75) Inventors: Ying LIU, Hung Hum (CN); Shou Lung CHEN, Shatin (CN)

Correspondence Address: MERCHANT & GOULD PC, P.O. BOX 2903, MINNEAPOLIS, MN, 55402-0903, US

(73) Assignee: Hong Kong Applied Science and Technology Research Institue Co., Ltd., Shatin (CN)

(21) Appl. No.: 12/054,595

(22) Filed: Mar. 25, 2008

(30) Foreign Application Priority Data
Mar. 27, 2007 (CN) 200710086968.0

(51) Int. Cl. G02B 19/00; G03B 21/14

(52) U.S. Cl. 353/102; 359/642

(57) ABSTRACT

An optical element and a projection system using the same are provided. The optical element comprises a light-condensing part for condensing lights from a light source, and the light-condensing part includes a reflecting surface and a refracting surface, and a light-guide part, coupled to an output end of the light-condensing part, for uniformly emitting the lights condensed by the light-condensing part. The optical element and the projection system of the present invention are capable of providing an enhanced light uniformity and a high light-coupling efficiency.

### FIELD OF THE INVENTION

The present invention relates to an optical element. More particularly, the present invention relates to an optical element applied in a projection system.

### BACKGROUND OF THE INVENTION

In recent years, as projectors have become used more and more widely, not only have the bodies of the projectors become thinner and thinner, but their efficiency has also been increased greatly. Compared with the early products, the brightness of the projector on the current market has been greatly improved by means of improving the light-emitting device in the projector, so that a clear projection effect can be achieved without turning down the indoor lights during projection. There have been many methods for improving the light-emitting device of the projector, for example, US Patent Publication Nos. 2005/017904 A1 and 2006/0164607 A1, which disclosed different light-emitting device structures to enhance the luminance or the light uniformity. In the former patent, a collimating lens covers an LED, and since the LED will emit lights at a certain angle, the arc surface of the collimating lens is designed to collimate the lights emitted from the LED. That is to say, the originally scattered lights are emitted from the collimating lens in a substantially parallel shape. Since this type of light-emitting device lacks a light-mixing device, the level of uniformity of the lights emitted from the collimating lens is not high enough. In this way, the problem of non-uniform luminance occurs in the projection picture. In the latter patent, a tapered light-guide part is used to mix the lights received from the LED thoroughly, so as to enhance the uniformity of the lights. However, the device has a defect because a part of the lights emitted by the LED is lost and cannot enter into the light-guide part totally, thus resulting in a low light-coupling efficiency.

Accordingly, an optical element with an enhanced light uniformity and a high light-coupling efficiency is indeed required.

### SUMMARY OF THE INVENTION

In view of the disadvantages of the conventional art, the present invention provides an optical element and a projection system using the same, which achieve an enhanced light uniformity and a high light-coupling efficiency.

According to an embodiment, the present invention provides an optical element, which includes: a light-condensing part, having a reflecting surface and a refracting surface, for collecting and condensing lights from a light source; and a light-guide part, coupled to an output end of the light-condensing part, for uniformly emitting the lights condensed by the light-condensing part.

According to another embodiment, the present invention provides a projection system, which includes a light-emitting device comprising at least one optical element and a light source for providing lights; a display module, coupled to an output end of a light-guide part of the light-emitting device, for providing an image to be displayed; and a projection lens, coupled to the display module, for projecting the image.

Since the light-condensing part is coupled to a light-emitting surface of the light source, and the reflecting surface is a total reflecting surface, most of the lights emitted from the light source can be collected. Additionally, the reflecting surface and the refracting surface can also make the lights coupled to the light-guide part with an extremely low loss, and then, the lights are mixed thoroughly by the light-guide part. Therefore, the optical element of the present invention has the advantages of both the high light-coupling efficiency and the high level of uniformity. In addition, the creative design of the optical element of the present invention can also reduce the number of required optical-coupling elements.

The accompanying drawings are included to provide a further understanding of the invention, and are incorporated in and constitute a part of this specification. The drawings illustrate embodiments of the invention and, together with the description, serve to explain the principles of the invention.

### BRIEF DESCRIPTION OF THE DRAWING

FIG. 1 is a cross-sectional view of an optical element applied in a light-emitting device according to a preferred embodiment of the present invention;

FIGS. 2a, 2b, and 2c are cross-sectional views of an optical element applied in a light-emitting device according to other preferred embodiments of the present invention;

FIG. 3 is a schematic view of a pen-like projection system according to a preferred embodiment of the present invention;

FIGS. 4a and 4b are schematic views of mini-projection systems according to two preferred embodiments of the present invention respectively;

FIG. 5 is a schematic view of a triple-module projection system according to the present invention; and

FIG. 6 is a schematic view of a reflective projection system according to the present invention.

### DETAILED DESCRIPTION OF THE INVENTION

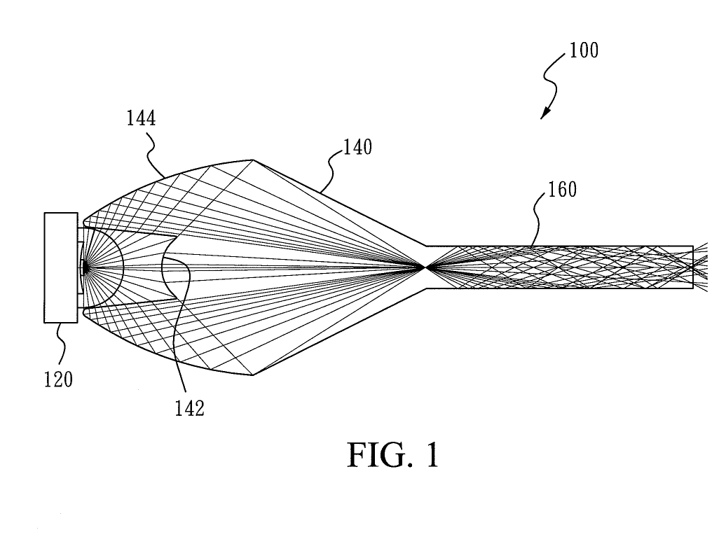

FIG. 1 is a cross-sectional view of an optical element applied in a light-emitting device 100 according to a preferred embodiment of the present invention. The light-emitting device 100 includes a light source 120 and an optical element. The optical element includes a light-condensing part 140 and a light-guide part 160, and the light-condensing part 140 has a refracting surface 142 and a reflecting surface 144. In this embodiment, the light-condensing part 140 and the light-guide part 160 can be formed integrally or composed of two components. The light source 120 can be a light-emitting diode (LED) (for example, a white LED) or an LED assembly (for example, composed of red, green, and blue LEDs) for emitting light simultaneously or successively under control. The light source 120 can also be other light-emitting elements (such as an ordinary bulb or solid light-emitting device). As shown in FIG. 1, one end of the light-condensing part 140 is coupled to the light source 120 to receive the lights emitted thereby. After passing through the refracting surface 142, a part of the lights is concentrated on the output end of the light-condensing part 140, i.e., an input end of the light-guide part; similarly, the other part of the lights is concentrated on the output end of the light-condensing part 140 after being reflected by a reflecting surface 144. After entering the light-guide part 160, the lights will undergo a series of internal reflections, so that the lights emitted from the output end of the light-guide part 160 have a high level of uniformity. According to an embodiment of the present invention, it should be understood by a person of ordinary skill in the art that the optical element can be an individual element or combined with a light source to form a light-emitting device.

It should be noted that, although the reflecting surface 144 is a total internal reflecting surface or coated with a reflecting layer, and the refracting surface 142 and the reflecting surface 144 are both non-spherical arced surfaces in a preferred embodiment of the present invention, in other embodiments, the refracting surface 142 can also be a flat surface or a spherical arced surface, or the refracting surface 142 is a non-spherical arced surface and the reflecting surface 144 is a spherical arced surface or step-like ring. Additionally, the light-guide part 160 in the above embodiment can be column-shaped, for example, a tetragonal column, a circular cylinder, or a polygonal column with other cross section, and each cross-sectional area of the light-guide part is the same.

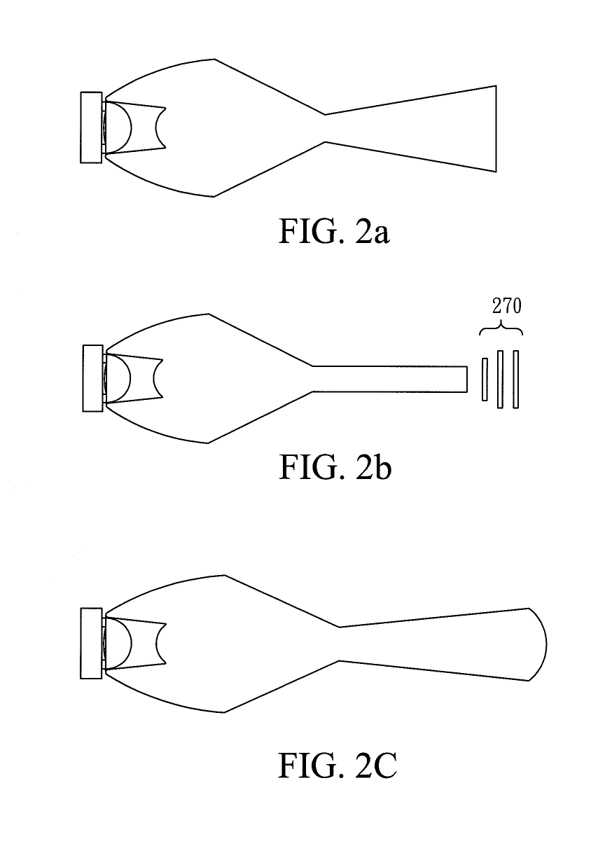

FIGS. 2a and 2b are cross-sectional views of an optical element applied in a light-emitting device according to other preferred embodiments of the present invention. When being applied in a projection system with a larger display module, the cross-sectional area of the output light beam of the optical element of the present invention must be enlarged. Therefore, as shown in FIG. 2, the cross-sectional area of the output end of the light-guide part is larger than that of the input end, that is to say, the lights are gradually expanded by the tapered light-guide part when being mixed uniformly, so as to get a light beam with a larger cross section. Moreover, as shown in FIG. 2b, a beam expander 270, such as a relay lens set, can also be disposed on the back end of the cylindrical shaped light-guide part to expand the light beam. Additionally, as shown in FIG. 2c, regardless of the shape of the light-guide part, the output end can be a convex surface or a concave surface, because the convex surface or the concave surface can achieve the effect of a lens, so as to improve the light efficiency and change the shape of the output light. A geometrical pattern or a rough surface can also be formed on the output end of the light-guide part to improve the light efficiency and the uniformity.

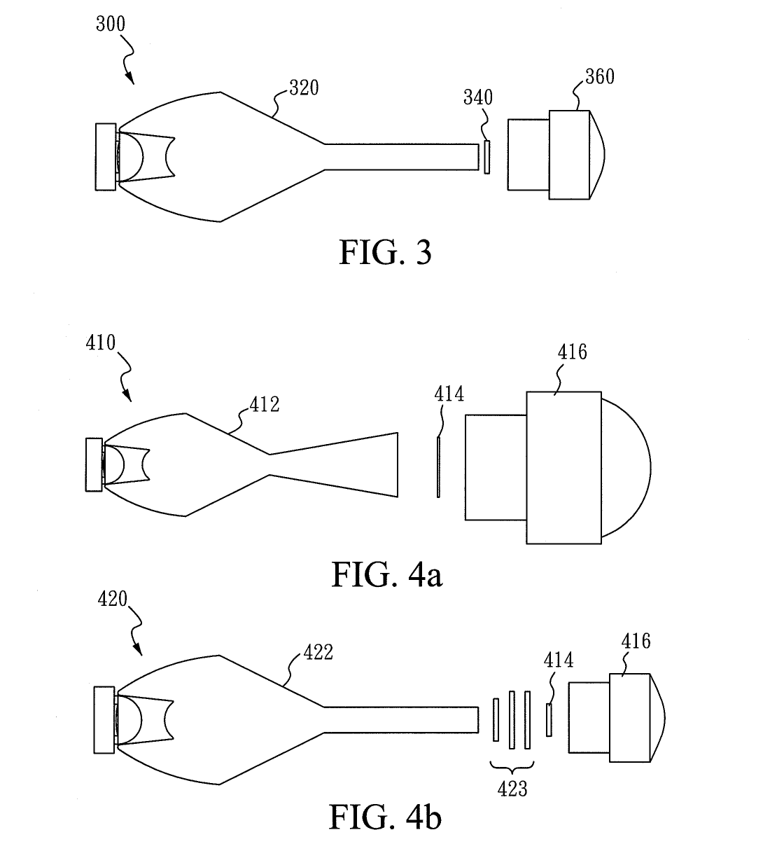

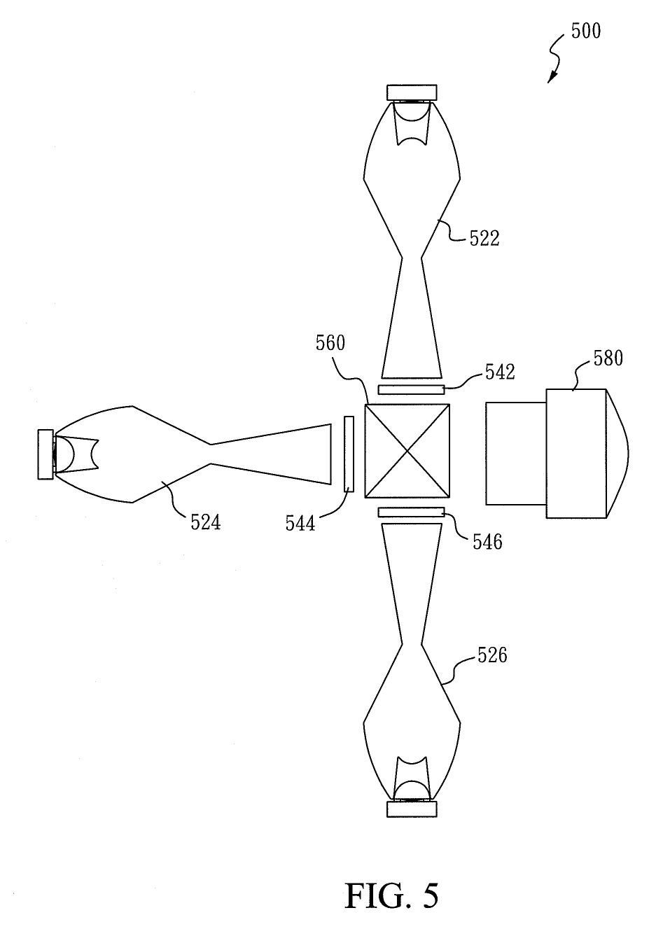

The light-emitting device and the optical element of the present invention can be applied in various projection systems (for example, a handheld projection system), and the applications of the light-emitting device and the optical element will be further described hereinafter. FIG. 3 is a schematic view of a pen-like projection system 300 according to a preferred embodiment of the present invention. As shown in FIG. 3, the pen-like projection system 300 includes a light-emitting device 320, a display module 340 coupled to an output end of the light-emitting device 320, for providing an image to be displayed, and a projection lens assembly 360 coupled to the display module 340, for projecting the image. In this embodiment, the display module 340 can be a high-temperature poly-silicon liquid crystal display (HTPS-LCD) or another transmission-type display module. In addition, FIGS. 4a and 4b are schematic views of mini-projection systems 410 and 420 according to the preferred embodiments of the present invention respectively. As shown in FIG. 4a, the structure of the mini-projection systems 410 is similar to that of the pen-like projection system 300 in FIG. 3, with the main difference lying in the fact that the light-guide part of the light-emitting device 412 in the mini-projection system 410 is tapered. The body of the mini-projection system 410 is larger than that of the projection system 300, and the area of the used display module 414 is also relatively large, so a tapered light-guide part is required to expand the light beam. Similarly, such an expanding function can also be achieved by a beam expander 423 shown in FIG. 4b. Besides the application of a single light-emitting device, the projection system of the present invention can also use a plurality of light-emitting devices. FIG. 5 is a schematic view of a triple-module projection system 500 according to an embodiment of the present invention. As shown in FIG. 5, the triple-module projection system 500 includes light-emitting devices 522, 524, and 526, display modules 542, 544, and 546, an integrator 560, and a projection lens 580. The light-emitting devices 522, 524, and 526 respectively emit red, blue, and green lights, which pass through the corresponding display modules 542, 544, and 546 and are then mixed by the integrator 560 to generate a color image.

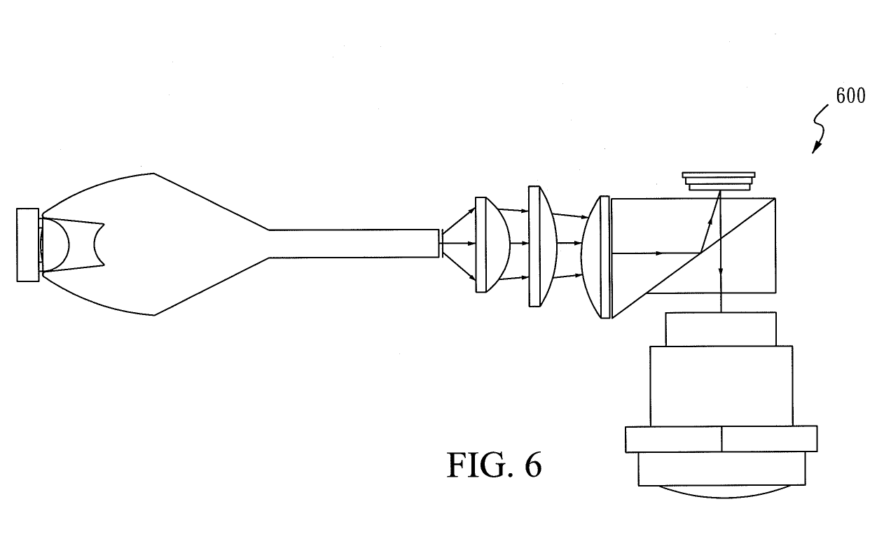

Additionally, the optical element and the light-emitting device of the present invention not only can be applied in the transmission-type projection system in FIGS. 3, 4a, 4b, and 5, but can also be applied in a reflective-type projection system. For example, FIG. 6 is a schematic view of a reflective projection system 600 according to a preferred embodiment of the present invention. The display module used in the reflective projection system can be a digital micromirror device (DMD), or a liquid crystal on silicon (LCOS). If the light-emitting device adopts a light source with more than three colors to be synthesized into a white light, various light sources with different colors respectively emit lights sequentially, the color wheel in the conventional projection system can be omitted, and thus, the utilization ratio of the lights can be increased by 200%.

Though the above projection system only utilizes, for example, the optical element with the cylindrical-shaped light-guide part, the optical element with the tapered shaped light-guide part, or the optical element with the beam expander, the projection systems implemented by the optical element and the light-emitting device according to other embodiments of the present invention are not limited to the above. The optical element of the present invention can increase the light-coupling efficiency by over 90% and increase the uniformity by over 85% by means of disposing the light-condensing part for covering the light source and the light-guide part for mixing the lights thoroughly. Additionally, the creative design of the optical element in the present invention can also reduce the number of the required optical-coupling elements.

Although the technical content and technical features of the present invention have been disclosed above, it will be apparent to those skilled in the art that various alternations and modifications can be made without departing from the scope or spirit of the invention based on the teaching and disclosure of the present invention. Therefore, the scope of protection of the present invention is not limited to the disclosure of the embodiments, but covers various alternations and modifications without departing from the present invention, and is defined by the scope of the following claims.

What is claimed is:

1. An optical element, comprising:
a light-condensing part, having a reflecting surface and a refracting surface, for collecting and condensing lights from a light source; and
a light-guide part, coupled to an output end of the light-condensing part, for uniformly emitting the lights condensed by the light-condensing part.

2. The optical element as claimed in claim 1, wherein the refracting surface is a aspherical arced surface, for refracting and condensing the lights from the light source to the output end.

3. The optical element as claimed in claim 1, wherein the reflecting surface is a total internal reflecting surface, for reflecting and condensing a part of the lights refracted by the refracting surface to the output end.

4. The optical element as claimed in claim 1, wherein the reflecting surface is coated with a reflecting layer, for reflecting and condensing a part of the lights refracted by the refracting surface to the output end.

5. The optical element as claimed in claim 1, wherein the light-guide part is column-shaped; and each cross-sectional area of the light-guide part is the same.

6. The optical element as claimed in claim 1, wherein the light-guide part is tapered; and a cross-sectional area of an input end of the light-guide part is smaller than that of an output end of the light-guide part.

7. The optical element as claimed in claim 5, wherein the column-shaped light-guide part is of the shape of a tetragonal column, a circular cylinder, or a polygonal column with other cross section.

8. The optical element as claimed in claim 1, further comprising a beam expander, coupled to an output end of the light-guide part, for expanding the lights emitted by the light-guide part.

9. The optical element as claimed in claim 1, wherein an output end of the light-guide part is a convex surface, for enhancing a light efficiency of the optical element.

10. The optical element as claimed in claim 1, wherein an output end of the light-guide part is a concave surface, to change the shape of light beam outputted from the optical element.

11. The optical element as claimed in claim 1, wherein an output end of the light-guide part has a pattern to enhance the light efficiency and uniformity of the optical element.

12. A projection system, comprising:
a light-emitting device, comprising:
a light source for providing lights;
at least one optical element as claimed in claim 1, coupled to the light source;
a display module, coupled to an output end of a light-guide part of the optical element emitting device, for providing an image to be displayed; and
a projection lens assembly, coupled to the display module, for projecting the image.

13. The projection system as claimed in claim 12, wherein a refracting surface of the optical element is a aspherical arced surface, for refracting and condensing the lights from the light source to the output end.

14. The projection system as claimed in claim 12, wherein a reflecting surface of the optical element is a total internal reflecting surface, for reflecting and condensing a part of the lights refracted by the refracting surface to the output end.

15. The projection system as claimed in claim 12, wherein the reflecting surface of the optical element is coated with a reflecting layer, for reflecting and condensing a part of the lights refracted by the refracting surface to the output end.

16. The projection system as claimed in claim 12, wherein the light-guide part of the optical element is column-shaped; and each cross-sectional area of the light-guide part is the same.

17. The projection system as claimed in claim 12, wherein the light-guide part of the optical element is tapered; and a cross-sectional area of an input end of the light-guide part is smaller than that of an output end of the light-guide part.

18. The projection system as claimed in claim 16, wherein the column-shaped light-guide part is of the shape of a tetragonal column, a circular cylinder, or a polygonal column with other cross section.

19. The projection system as claimed in claim 12, further comprising a beam expander, coupled to an output end of the light-guide part of the optical element, for expanding the lights emitted by the light-guide part.

20. The projection system as claimed in claim 12, wherein an output end of the light-guide part of the optical element is a convex surface, to enhance a light efficiency of the optical element.

21. The projection system as claimed in claim 12, wherein an output end of the light-guide part of the optical element is a concave surface, to change the shape of light beam outputted from the optical element.

22. The projection system as claimed in claim 12, wherein an output end of the light-guide part of the optical element has a pattern to enhance the light efficiency and uniformity of the optical element.

23. The projection system as claimed in claim 12, wherein the light source is an ordinary bulb, a solid light-emitting element, a light-emitting diode (LED), or an LED array.

24. The projection system as claimed in claim 23, wherein the LED is a white LED.

25. The projection system as claimed in claim 23, wherein the LED array comprises at least a red LED, a green LED, and a blue LED, for emitting lights simultaneously or successively.

26. The projection system as claimed in claim 12, wherein the display module is a high-temperature polysilicon liquid crystal display (LCD), a digital micromirror device (DMD), or a liquid crystal on silicon (LCOS).

27. The projection system as claimed in claim 12, wherein the projection system is a handheld transmission-type projection system or a reflective projection system.

28. The projection system as claimed in claim 12, wherein the projection system is a pen-like projection system or a mini-projection system.

29. The projection system as claimed in claim 12, wherein the projection system is a triple-module projection system.
